(19) United States
(12) Patent Application Publication
(10) Pub. No.: US 2026/0330510 A1
(43) Pub. Date: Oct. 22, 2026

(54) SYSTEM AND METHOD FOR OPTIMIZING AD LOAD TIMES BY IMPLEMENTING ADS FETCHING IN DYNAMICALLY GENERATED BATCHES

(71) Applicant: Yahoo Ad Tech LLC, New York, NY (US)

(72) Inventors: Shu YANG, Broadlands, VA (US); Suchith CHANDRAN, Fremont, CA (US); Amit AGARWAL, Mountain House, CA (US); Matt CHAIM, Fort Lauderdale, FL (US); FNU SHRISHTI, Milpitas, CA (US)

(21) Appl. No.: 19/184,799

(22) Filed: Apr. 21, 2025

(51) Int. Cl. G06Q 30/0273; G06Q 30/0241

(52) U.S. Cl. CPC G06Q 30/0275; G06Q 30/0277

(57) ABSTRACT

Systems and methods are disclosed for optimizing webpage loading times. One method may include receiving one or more content slots of a webpage, classifying the one or more content slots, batching the one or more content slots based on the classifying of the one or more content slots, customizing one or more bid requests corresponding to each batch of the one or more content slots, transmitting the one or more customized bid requests to an auction manager, receiving, from the auction manager, one or more winning bids for each of the one or more bid requests, and loading the one or more content slots of the webpage with one or more electronic content items corresponding to the one or more winning bids.

### TECHNICAL FIELD

The present disclosure relates generally to customized pre-bid auctions of select electronic content inventory slots and, more particularly, to systems and methods for customized pre-bid auctions of select electronic content inventory slots.

### BACKGROUND

Web publishers face a fundamental trade-off between maximizing ad revenue and ensuring a fast, seamless web viewing experience. For example, holding web advertisement slot auctions allows web publishers to receive ad revenue for ads placed on a website. Holding an auction open for a longer period generally allows publishers to receive more bid requests, which increases competition among advertisers, results in higher ad revenue. However, this strategy comes with risks as longer auctions introduce latency, delaying the rendering of ads, and more importantly, slowing down overall page load times.

Alternatively, prioritizing speed by accepting bids quickly generally enhances a user's experience, leading to higher engagement and retention rates. Slow-loading pages frustrate users, increasing bounce rates and negatively impacting search engine rankings, as page speed is a critical factor in SEO performance. However, the downside of this approach is that accepting bids too quickly may prevent advertisers from entering the auction, leading to lower competition and reduced ad revenue.

There exists a need for publishers to be able to quickly load a website while also maximizing ad revenue generated from an auction. In addition, publishers would benefit greatly from a way to determine an optimal balance between revenue generation and user satisfaction.

The present disclosure is directed to overcoming one or more of these above-referenced challenges.

### SUMMARY OF THE DISCLOSURE

According to certain aspects of the disclosure, systems and methods are disclosed for a computer-implemented method for optimizing webpage loading times, the method including: receiving, by one or more processors, one or more content slots of a webpage; classifying, by the one or more processors, the one or more content slots; batching, by the one or more processors, the one or more content slots based on the classifying of the one or more content slots; customizing, by the one or more processors, one or more bid requests corresponding to each batch of the one or more content slots; transmitting, by the one or more processors, the one or more customized bid requests to an auction manager; receiving, from the auction manager, by the one or more processors, one or more winning bids for each of the one or more bid requests; and loading, by the one or more processors, the one or more content slots of the webpage with one or more electronic content items corresponding to the one or more winning bids.

In some aspects, the techniques described herein relate to a system for optimizing webpage loading times, the system including: a data storage device storing instructions for optimizing webpage loading in an electronic storage medium; and a processor configured to execute the instructions to perform a method including: receiving one or more content slots of a webpage; classifying the one or more content slots; batching the one or more content slots based on the classifying of the one or more content slots; customizing one or more bid requests corresponding to each batch of the one or more content slots; transmitting the one or more customized bid requests to an auction manager; receiving, from the auction manager, one or more winning bids for each of the one or more bid requests; and loading the one or more content slots of the webpage with one or more electronic content items corresponding to the one or more winning bids.

In some aspects, the techniques described herein relate to a non-transitory machine-readable medium storing instructions that, when executed by a computing system, causes the computing system to perform a method for optimizing webpage loading times, the method including: receiving, by one or more processors, one or more content slots of a webpage; classifying, by the one or more processors, the one or more content slots; batching, by the one or more processors, the one or more content slots based on the classifying of the one or more content slots; customizing, by the one or more processors, one or more bid requests corresponding to each batch of the one or more content slots; transmitting, by the one or more processors, the one or more customized bid requests to an auction manager; receiving, from the auction manager, by the one or more processors, one or more winning bids for each of the one or more bid requests; and loading, by the one or more processors, the one or more content slots of the webpage with one or more electronic content items corresponding to the one or more winning bids.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. As will be apparent from the embodiments below, an advantage to the disclosed systems and methods is that multiple parties may fully utilize their data without allowing others to have direct access to raw data. The disclosed systems and methods discussed below may allow advertisers to understand users' online behaviors through the indirect use of raw data and may maintain privacy of the users and the data.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a schematic diagram illustrating an example environment implementing methods and systems of this disclosure, according to one or more embodiments.

FIG. 2 depicts a flow diagram of an exemplary method for optimizing ad load times by implementing ads fetching in dynamically generated batches, according to one or more embodiments.

FIG. 3 depicts an exemplary model that illustrates ads fetching using generated batches.

FIG. 4 depicts an exemplary model that chronologically illustrates ads fetching using generated batches.

FIG. 5 depicts an example system that may execute techniques presented herein.

### DETAILED DESCRIPTION OF EMBODIMENTS

According to certain aspects of the disclosure, methods and systems are disclosed for optimizing ad load times by implementing ads fetching in dynamically generated batches. Conventional techniques may not be suitable because conventional techniques, among other things, are unable to provide a customized process that is specific towards optimizing ad load times of a webpage. Accordingly, improvements in technology relating to the optimization of ad load times by fetching ads based on dynamically generated batches are needed.

To generate revenue, websites will often include ads that are provided to a user. To receive ads for placement within different ad slots on a webpage, an ad auction is conducted by transmitting bid requests and allowing marketing campaign managers to bid on the ad space. Generally, the longer an auction remains open, the more revenue an ad slot may generate.

Holding an auction for extended periods of time, however, has negative consequences. For example, a user's experience may be negatively impacted when holding an auction open for extended periods of time, because doing so will result in a longer load-time for a webpage. In many situations, a website with a slow loading time may cause users to be impatient and move on to another website.

Conventional methods of sending bid requests via a bid auction do not include a way to optimize ad load times or revenue. Instead, conventional systems either prioritize loading a webpage quickly by conducting a short auction, which results in less ad revenue, or prioritize greater monetization by waiting for higher bids in an ad auction, which results in slower webpage loading times.

This disclosure provides systems and methods for optimizing webpage loading times and revenue generation. The systems and methods may include receiving, by one or more processors, one or more content slots of a webpage. The systems and methods may include classifying, by the one or more processors, the one or more content slots. The systems and method may include batching, by the one or more processors, the one or more content slots based on the classifying of the one or more content slots. The systems and method may include customizing, by the one or more processors, one or more bid requests corresponding to each batch of the one or more content slots. The systems and method may include transmitting, by the one or more processors, the one or more customized bid requests to an auction manager. The systems and method may include receiving, from the auction manager, by the one or more processors, one or more winning bids for each of the one or more bid requests. The systems and method may include loading, by the one or more processors, the one or more content slots of the webpage with one or more electronic content items corresponding to the one or more winning bids.

Advantages of such systems and method may include customization of ad slots for auction. By customizing ad slots for auction, a web publisher has the advantage of optimizing both revenue and loading times for a web page. For example, determining that a first batch of ad slots at the top of a webpage is to have a shorter auction than a second batch of ad slots will allow the ad slots of the first batch to be filled quicker, resulting in a quicker loading time for the top of the webpage. At the same time, by keeping an auction open longer for the second batch of ad slots lower down on the webpage, a web publisher will be able to receive higher bids for the second batch of ad slots.

Additionally, determining how to group the ad slots is an advantage over conventional systems and method. Web publishers may desire the ability to analyze auction data quickly and accurately, to determine optimized customizations for implemented batch bid requests. An individual attempting to optimize revenue and load times for ad slots would likely lead to inefficiencies and errors in consideration of the amount of data necessary to process historical auction data, and the speed at which the determination would need to be made would not likely be able to be met by a person as these determinations would need to be made in one to two seconds.

The terminology used below should be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, relative terms, such as, for example, “about,” “substantially,” “generally,” and “approximately” are used to indicate a possible variation of ±10% in a stated value. The term “exemplary” is used in the sense of “example” rather than “ideal.” As used herein, the singular forms “a,” “an,” and “the” include plural reference unless the context dictates otherwise.

As used herein, the terms “advertisements” or “ads” may include digital marketing tools used to promote products, services, or content to users. Ads may include various formats, including banner ads, pop-ups, native ads, video ads, and sponsored content. Advertisements may be used by website owners to monetize their platforms by displaying ads through networks like Google AdSense or direct partnerships with advertisers.

As used herein, “ad slots” or “content slots” may include specific areas of a website designated for displaying “ads” or advertisements. These slots may be predefined by a website owner or publisher, and can be filled with various types of ads, such as banners, videos, or native ads. Ad slots may include location sections of a webpage, such as a header, sidebar, within content, footer, etc., a size and format, and may be bid on by advertisers through an auction and bidding process, or through some other programmatic ad exchange.

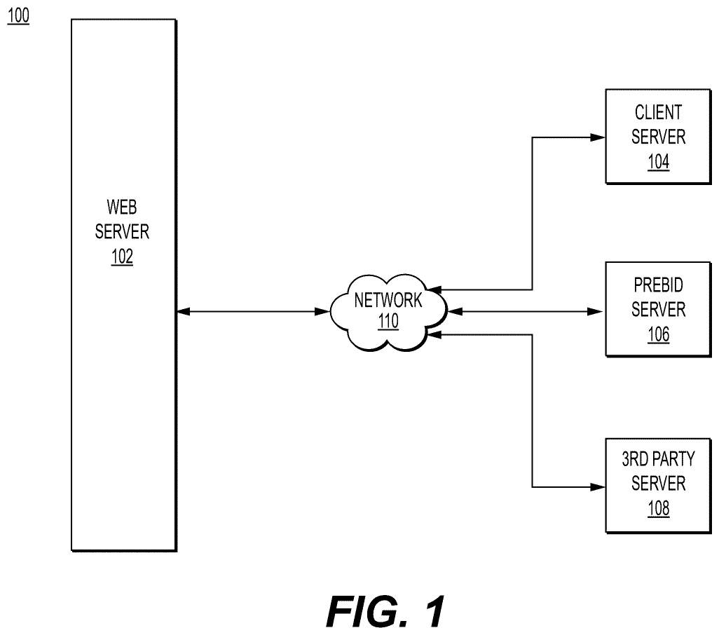

FIG. 1 depicts an exemplary environment 100 that may be utilized with the techniques, including the systems and method presented herein. As FIG. 1 shows, a web server 102, client server 104, pre-bid server 106, and a third-party server 108, may communicate across a network 110. As discussed in further detail below, one or more server systems may communicate with one or more of the other components of the environment 100 across network 110. While FIG. 1 depicts a single web server 102, client server 104, pre-bid server 106, and third-party server 108, each of web server 102, client server 104, pre-bid server 106, and third-party server 108, may also consist of one or more servers connected over network 110. The systems and devices of environment 100 may communicate in any arrangement, including an arrangement other than what FIG. 1 illustrates.

Web server 102 may include a hardware system that hosts a website and serves web pages to users over the internet. Web server 102 may receive requests from web browsers or other clients and may respond by delivering the requested content, such as HTML files, images, scripts, or other resources. Web server 102 may include software that processes incoming requests and serves the requested files, and hardware, which may include a physical computer that runs the web server software and stores the website's files to make them available to users over the network. Web server 102 may process incoming requests and send the webpage data back to a web browser of a user device.

Client server 104 may facilitate electronic communications between web server 102 and advertising partners. Advertising partners may include brands or businesses that want to display their ads on websites to reach their target audience, demand-side platforms (DSPs) which may include automated platforms that allow advertisers to bid on ad slots in real time, ad exchanges or marketplaces where ad inventory is auctioned in real time to the highest bidder, ad networks and companies that may aggregate ad inventory from multiple websites and sell it to advertisers, or any other organization that bids on ad slots of a website.

Pre-bid server 106 may facilitate electronic communications between web server 102 and advertising partners that may have an already existing relationship with web server 102. For example, pre-bid server 106 may include brands or businesses that have already displayed an ad on a website hosted by web server 102 and want to do so again, demand-side platforms (DSPs) which may include automated platforms that allow returning advertisers to bid on ad slots in real time, ad exchanges or marketplaces where ad inventory is auctioned to advertisers, that have previously bid on ad slots, in real time to the highest bidder, or any other organization that bids on ad slots of a website that they have also bided on in the past.

Third-party server 108 may facilitate electronic communications between web server 102 and third-party advertising partners. For example, third-party server 108 may include a platform that hosts and delivers advertisements on behalf of advertisers and agencies. Third-party server 108 may also manage ad creatives, track performance, and optimize ad placements across multiple websites. Third-party server 108 may provide ad hosting services, by storing ad creatives (images, videos, banners, etc.), and delivering ad when a webpage loads, by serving the ad to a visitor based on targeting criteria. Third-party server 108 may collect data on impressions, clicks, conversions, and engagement for performance analysis. Examples of third-party server 108 may include, but are not limited to, Google Campaign Manager and Adform.

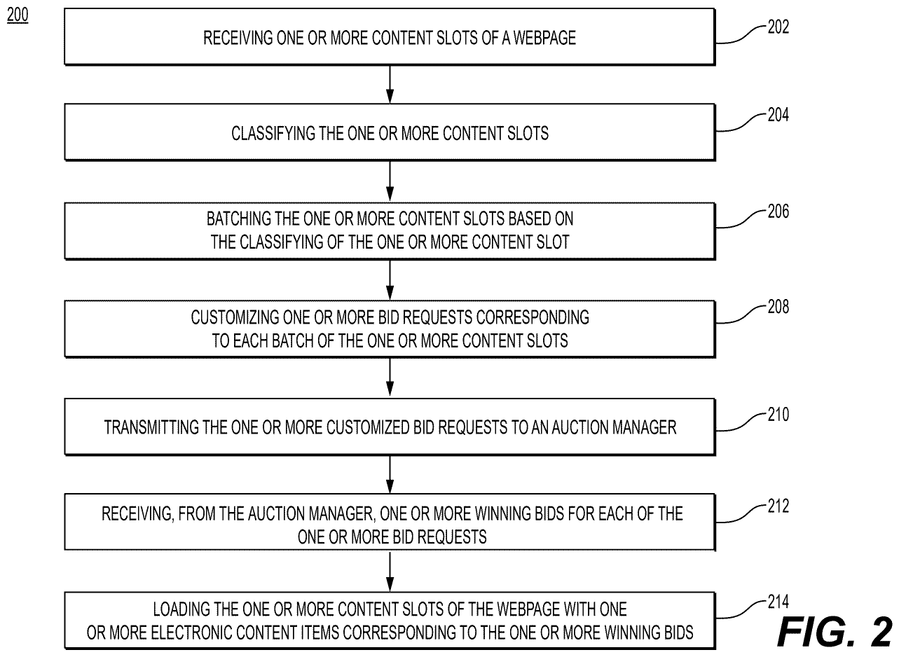

FIG. 2 depicts an exemplary process 200 for implementing embodiments of the present disclosure. In some embodiments, process 200 may include a step 202, receiving one or more content slots of a webpage, by a processor of a web server, such as web server 102. Exemplary embodiments may include a web publisher identifying and storing data pertaining to the ad slots, or computer-readable memory that includes instruction pertaining to the location of the one or more ad slots. In another exemplary embodiment a web developer may include web coding instruction, such as HTML, which identifies the one or more ad slots of a webpage.

In some embodiments, process 200 may include a step 204, classifying the one or more content slots. Classifications may be based on position, format, functionality, and bidding method, or other labels as are known in the art.

On one exemplary embodiment, classifying one or more content slots may be based on a position of the one or more content slots on the webpage. Position based classifications may include classifying ad slots that are above the fold, or those slots that are visible without scrolling (e.g., top banners, sticky ads). Classifying one or more content slots above a fold may include classifying a first batch of electronic content items that are located above a horizontal threshold of a webpage and classifying a second batch of electronic content items that are located below the horizontal threshold of the webpage. Ad slots that are classified as below the fold may include slots that require scrolling to view (e.g., in-content, sidebar ads). Position classifications may also include header ads positioned at the top of the page, sidebar ads placed on the side of content (left or right), or footer ads displayed at the bottom of a webpage. Position classifications may also include in-content ad slots, such as those that may be embedded within articles or blog posts, and sticky ad slots that remain visible when users scroll (e.g., floating banners). Other classifications based on position, which are known in the art, may also be implemented by process 200.

Classifications may also be based on ad format. For example, banner ad slots may be classified as standard image-based display ads (e.g., 728×90 or 300×250 resolution). Video ad slots may include slots designated for short video commercials (pre-roll, mid-roll, outstream). Native ad slots may be classified as those slots that seamlessly blend with website content. Pop-up/pop-under ads may be classified as those that appear in separate windows. Interstitial ads may be classified as full-screen ads that are displayed between content. Rich media ads may be classified as those that are interactive ads, such as by including animations, hover effects, etc. Other classifications based on format, that are known in the art, may also be implemented by process 200.

Classifications may also be based on ad functionality. For example, static ad slots may be classified as those slots that include fixed images or banners. Dynamic ad slots may include those slots that change content based on user behavior (e.g., retargeting ads). Expandable ad slots may be classified as those that expand when clicked or hovered over. Responsive ad slots may be classified as those that adjust automatically to different screen sizes. Other classifications based on functionality, which are known in the art, may also be implemented by process 200.

Classifications may also be based on bidding method. In one exemplary embodiment, classifying one or more content slots may be based on one or more auction controls including a bid timeout, start delay, and bidder preference. In another exemplary embodiment, guaranteed/direct buy ad slots may be classified as those auctions where advertisers purchase specific ad slots directly from publishers, such as those that may be facilitated by pre-bid server 106. Alternatively, a classification may include past ad slot purchasers, or ad purchasers that have a relationship with publishers of webpage 302.

Programmatic ad slots may be classified by those slots that are bought through automated real-time bidding (RTB) systems, such as those that would be conducted by client server 104. Header bidding slots may be classified as those slots that allow multiple ad exchanges to bid simultaneously before the page loads. Remnant ad slots may be classified as those slots that are unsold and filled with lower-paying ads. Other classifications based on bidding method, which are known in the art, may also be implemented by process 200.

Classifying (and batching) one or more content slots may also be determined by a trained machine learning model. In one exemplary embodiment, a machine learning system may include receiving training data (e.g. over a predetermined time period), analyzing the training data to determine associations, and generating a model and/or algorithms based on the determined associations. The model and/or algorithms may be further fine-tuned as more training data and real data is provided. In this exemplary embodiment, a machine learning system may receive training data including ad slot classifications, batching groups, ad revenue generated for auctions, and webpage loading/lag time. This information may be analyzed to determine associations. Based on the associations, a machine learning model and one or more algorithms may be determined to provide for predictive associations and outcomes.

In some embodiments, process 200 may include a step 206, batching the one or more content slots based on the classifying of the one or more content slot. In one exemplary embodiment, a batch of content slots may include only those slots with the same classification. In another exemplary embodiment, a batch may include plural classifications of various ad slots.

In some embodiments, process 200 may include a step 208, customizing one or more bid requests corresponding to each batch of the one or more content slots. A bid request may be sent in a standardized format that is compatible between platforms and ad exchanges. For example, a JSON (JavaScript Object Notation) format, may be used in a bidding protocol. A bid request may be customized in a number of ways. For example, standard customized bid requests may include user data (IP address, location, device type, browsing behavior), ad slot details (size, format, placement), publisher information, and allowed ad types and restrictions. Step 208 of process 200 may include further classifying a bid request based on the customized batches.

In some embodiments, process 200 may include a step 210, transmitting the one or more customized bid requests to an auction manager, such as an auction manager corresponding with client server 104 or pre-bid server 106. In one exemplary embodiment, transmitting the one or more customized bid requests to the auction manager may include transmitting a first batch of electronic content items prior to transmitting a second batch of electronic content items.

An auction manager may hold an auction and determine a winning bid for each of the batched bid requests. After determining a winning bid, the winning bid may be transmitted to web server 102. Step 212 of process 200 may include web server 102 receiving one or more winning bids for each of the one or more bid requests. In some embodiments, process 200 may include a step 214, loading the one or more content slots of the webpage with one or more electronic content items corresponding to the one or more winning bids. In one exemplary embodiment, loading one or more content slots of the webpage may include loading a first batch of electronic content items prior to loading a second batch of electronic content items.

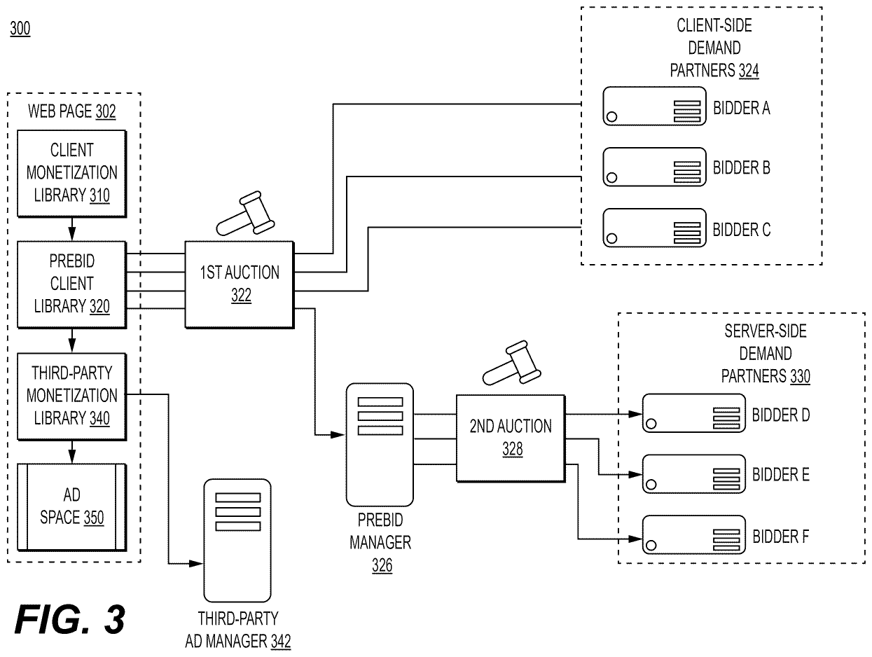

FIG. 3 depicts an exemplary flowchart 300 that may be utilized with the techniques and methods presented herein, such as in FIG. 2. In an exemplary embodiment, when a user visits a webpage, client monetization library 310 may include the classification and batching of ad slots of webpage 302, as described in exemplary embodiments corresponding with step 202, step 204, step 206, and step 208 of FIG. 2. The customized batches may be transmitted from client monetization library 310 to prebid client library 320 to initialize an ad auction. In this exemplary embodiments, customized batches include a first batch with classifications that relate to bidders that have prior history with a web publisher for webpage 302. The prior history may include winning a past ad slot auction or previously bidding on a past ad slot auction for webpage 302, the website of webpage 302, or a web publisher of webpage 302. In this exemplary embodiment, a second batch of ad slots have been classified to include ad slot bidders that have never interacted with, or have no prior history with, webpage 302.

Based on the customized bid requests, a first auction 322 may take place at the client-side level, where client-side demand partners 324 (bidders A, B, and C) may submit ad slot bids directly to the web page publisher. In this exemplary embodiment, bidders A, B, and C, are bidders that have completed, or attempted to complete, an ad bid requests in the past.

Next, a second auction 328 may occur at the server-side demand partners 330, where additional bidders (D, E, and F) may participate. In this exemplary embodiment, second auction 328 may include a server-side bidding auction conducted by prebid manager 326. This process includes using one or more external servers, e.g., a prebid server, to conduct second auction 328, which may cause additional latency.

Prebid client library 320 may then receive the winning bids from both first auction 322 and second auction 328. Webpage 302 may also include third-party client monetization library 340 requesting an ad bid through third-party ad manager 342. Webpage 302 may then provide the winning bid requests, and any content determined by third-party ad manager 342, to ad space 350 for display on the ad space(s) of webpage 302.

Exemplary flowchart 300 provides a way to customizable batch ad slots for auction. Doing so allows a web publisher to optimize loading times in consideration of ad revenue. In this exemplary embodiment, integrating prebid client library 320 (prebid.js) for client-side auctions and server-side connections auctions, may achieve higher revenue for ad load batches in second auction 328 while also facilitate quick load times for portions of webpage 302 that have ad slots batched in first auction 322.

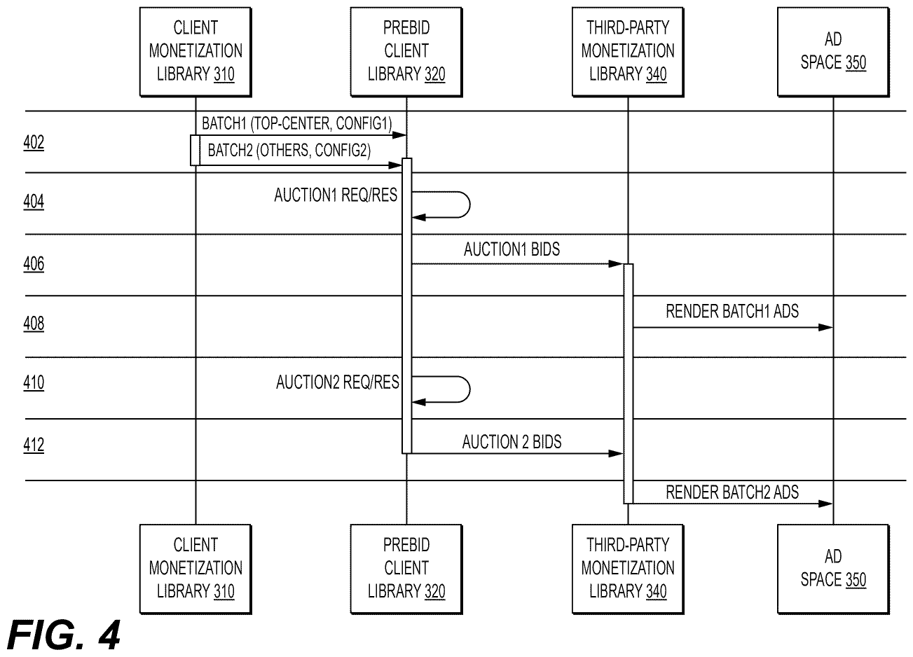

FIG. 4 depicts an exemplary process 400 of process 200 depicted in FIG. 2. In one exemplary embodiment, step 202, step 204, step 206, and step 208, have all taken place and customized ad slot batches may be ready for auctioning and stored in client monetization library 310. Exemplary process 400 may begin with step 402, client monetization library 310 transmitting customized bid request batches to prebid client library 320. In this exemplary embodiment, two batches are transmitted to prebid client library 320. Batch1 (top-center, config1) is classified for a specific ad placement location (e.g., top-center, above the fold) using a defined code configuration (config1). Batch2 may include other ad placement locations (ad slots below the fold) governed by a different code configuration (config2). While this exemplary embodiment includes customization based on position, other classifications may exist for which batching may be based on.

Exemplary process 400 may proceed with a first auction request at step 404 labeled as auction1 req/res. This exemplary request may be sent to bidders, typically via the prebid client library 320. At step 406, auction responses (auction1 bids) may be received and processed by third-party client monetization library 340. Based on the highest bids, the system may render batch1 ads in ad space 350 of the website. In this manner, webpage load times are reduced because the customized batch1 ads are processed to ad space 350 despite other ad slots (those in batch2, below the fold) not yet receiving a bid response.

Following the auction and rendering of the ad slots of the first batch, exemplary process 400 may include initiating a second auction at step 410, labeled auction2 req/res. Step 410 may include gathering bids for the remaining ad placements in Batch2. The responses for this auction (auction2 bids) are received at step 412, after which the corresponding ads are rendered for Batch2.

Overall, this flowchart represents a structured and efficient client-side monetization strategy, where bid requests are grouped into batches, auctions are conducted for each batch separately, and ads are subsequently rendered based on the auction results. This approach optimizes ad revenue by leveraging multiple bidding sources while ensuring that the most relevant and highest-paying ads are quickly displayed in the available ad spaces.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

In general, any process or operation discussed in this disclosure that is understood to be computer-implementable, such as the systems or devices in the environment 100 of FIG. 1, or any of the processes illustrated in FIGS. 2-4, may be performed by one or more processors of a computer system as described herein. A process or a process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a multitude of computing devices. A memory of the computer system may include the respective memory of each computing device of the plurality of computing devices.

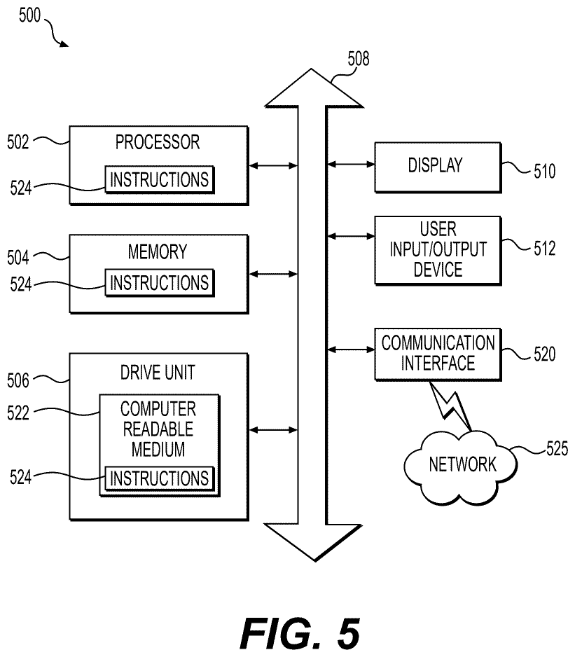

FIG. 5 is a simplified functional block diagram of a computer system 500 that may be configured as a device for executing the methods of FIGS. 2 and 3, according to exemplary embodiments of the present disclosure. For example, FIG. 5 illustrates an implementation of a computer system that may execute techniques presented herein. The computer system 500 can include a set of instructions that can be executed to cause the computer system 500 to perform any one or more of the methods or computer-based functions disclosed herein. The computer system 500 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 500 may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a personal digital assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 500 may be implemented using electronic devices that provide voice, video, or data communication. Further, while the computer system 500 is illustrated as a single system, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. The processor 502 may be a component in a variety of systems. For example, the processor 502 may be part of a standard personal computer or a workstation. The processor 502 may be one or more processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The computer system 500 may include a memory 504 that can communicate via bus 508. The memory 504 may be a main memory, a static memory, or a dynamic memory. The memory 504 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 504 may include a cache or random-access memory for the processor 502. In alternative implementations, the memory 504 is separate from the processor 502, such as a cache memory of a processor, the system memory, or other memory.

The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described herein may be performed by the processor 502 executing the instructions stored in the memory 504. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 500 may further include a display 510, such as a liquid crystal display (LCD), an organic light emitting diode (OLED), a flat panel display, a solid-state display, a cathode ray tube (CRT), a projector, a printer or other now known or later developed display device for outputting determined information. The display 510 may act as an interface for the user to see the functioning of the processor 502, or specifically as an interface with the software stored in the memory 504 or in the drive unit 506.

Additionally or alternatively, the computer system 500 may include an input/output device 512 configured to allow a user to interact with any of the components of the computer system 500. The input/output device 512 may be a number pad, a keyboard, or a cursor control device, such as a mouse, or a joystick, touch screen display, remote control, or any other device operative to interact with the computer system 500.

The computer system 500 may also or alternatively include drive unit 506, implemented as a disk or optical drive. The drive unit 506 may include a computer-readable medium 522 in which one or more sets of instructions 524, e.g., software, can be embedded. Further, instructions 524 may embody one or more of the methods or logic as described herein. The instructions 524 may reside completely or partially within the memory 504 and/or within the processor 502 during execution by the computer system 500. The memory 504 and the processor 502 also may include computer-readable media as discussed above.

In some systems, computer-readable medium 522 includes set of instructions 524 or receives and executes set of instructions 524 responsive to a propagated signal so that a device connected to network 525 can communicate voice, video, audio, images, or any other data over the network 525. Further, set of instructions 524 may be transmitted or received over the network 525 via communication port or interface 520, and/or using bus 508. The communication port or interface 520 may be a part of the processor 502 or may be a separate component. The communication port or interface 520 may be created in software or may be a physical connection in hardware.

The communication port or interface 520 may be configured to connect with a network 525, external media, the display 510, or any other components in computer system 500, or combinations thereof. The connection with the network 525 may be a physical connection, such as a wired Ethernet connection or may be established wirelessly as discussed below. Likewise, the additional connections with other components of the computer system 500 may be physical connections or may be established wirelessly. The network 525 may alternatively be directly connected to the bus 508.

While the computer-readable medium 522 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 522 may be non-transitory, and may be tangible.

The computer-readable medium 522 can include a solid-state memory such as a memory card or other package that houses one or more non-volatile read-only memories. The computer-readable medium 522 can be a random-access memory or other volatile re-writable memory. Additionally or alternatively, the computer-readable medium 522 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 500 may be connected to network 525. The network 525 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 525 may include wide area networks (WAN), such as the Internet, local area networks (LAN), campus area networks, metropolitan area networks, a direct connection such as through a Universal Serial Bus (USB) port, or any other networks that may allow for data communication.

The network 525 may be configured to couple one computing device to another computing device to enable communication of data between the devices. The network 525 may generally be enabled to employ any form of machine-readable media for communicating information from one device to another. The network 525 may include communication methods by which information may travel between computing devices.

The network 525 may be divided into sub-networks. The sub-networks may allow access to all the other components connected thereto or the sub-networks may restrict access between the components. The network 525 may be regarded as a public or private network connection and may include, for example, a virtual private network or an encryption or other security mechanism employed over the public Internet, or the like.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

The present embodiments envision collecting and analyzing user or customer data, such as mobile device data, vehicle, smart or autonomous data, vehicle telematics data, home telematics data, smart home data, smart appliance data, etc. associated with the user or customer devices or computing devices. Such data may be collected and analyzed once the user or customer affirmatively opts into a program, such as a customer loyalty or rewards program, or the customer otherwise affirmatively consents to data being generated by their devices being utilized, collected, and/or analyzed.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims. To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein.

Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations.

Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

1. A computer-implemented method for optimizing webpage loading times, the method comprising:
receiving, by one or more processors, one or more content slots of a webpage, the one or more content slots including a first group of content slots located above a horizontal threshold of the webpage and a second group of content slots located below the horizontal threshold of the webpage;
classifying, by the one or more processors, the first group of content slots as above-the-fold content slots and the second group of content slots as below-the-fold content slots based on a position of each content slot relative to the horizontal threshold;
batching, by the one or more processors, the first group of content slots into a first batch and the second group of content slots into a second batch based on the classifying;
customizing, by the one or more processors, a first transaction request corresponding to the first batch with a first parameter timeout value and a second transaction request corresponding to the second batch with a second parameter timeout value, wherein the first parameter timeout value is shorter than the second parameter timeout value;
transmitting, by the one or more processors, the first transaction request to an auction manager prior to transmitting the second transaction request;
receiving, from the auction manager, by the one or more processors, one or more first winning transactions for the first transaction request prior to receiving one or more second winning transactions for the second transaction request;
loading, by the one or more processors, the first group of content slots of the webpage with one or more first electronic content items corresponding to the one or more first winning transactions, thereby rendering the first group of content slots while the second transaction request is pending; and
loading, by the one or more processors, the second group of content slots of the webpage with one or more second electronic content items corresponding to the one or more second winning transaction after receiving the one or more second winning transactions

2. The computer-implemented method of claim 1, further comprising:
classifying the one or more content slots based on a position of the one or more content slots on the webpage.

3. (canceled)

4. (canceled)

5. The computer-implemented method of claim 1, wherein loading the one or more content slots of the webpage includes loading a first batch of electronic content items prior to loading a second batch of electronic content items.

6. The computer-implemented method of claim 1, wherein classifying the one or more content slots is based on one or more auction controls, the one or more auction controls comprising a bid timeout, a bid start delay, and bidder preference.

7. The computer-implemented method of claim 1, wherein classifying the one or more content slots of the webpage comprises classifying the one or more content slots using a trained machine learning model; and
batching the one or more content slots comprises batching the one or more content slots using the trained machine learning model.

8. A system for optimizing webpage loading times, the system comprising:
a data storage device storing instructions for optimizing webpage loading in an electronic storage medium; and
a processor configured to execute the instructions to perform a method including:
receiving one or more content slots of a webpage, the one or more content slots including a first group of content slots located above a horizontal threshold of the webpage and a second group of content slots located below the horizontal threshold of the webpage;
classifying the first group of content slots as above-the-fold content slots and the second group of content slots as below-the-fold content slots based on a position of each content slot relative to the horizontal threshold;
batching the first group of content slots into a first batch and the second group of content slots into a second batch based on the classifying;
customizing a first transaction request corresponding to the first batch with a first parameter timeout value and a second transaction request corresponding to slots the second batch with a second parameter timeout value, wherein the first parameter timeout value is shorter than the second parameter timeout value;
transmitting the first transaction request to an auction manager prior to transmitting the second transaction request;
receiving, from the auction manager, one or more first winning transactions for the first transaction request prior to receiving one or more second winning transactions for the second transaction request;
loading the first group of content slots of the webpage with one or more first electronic content items corresponding to the one or more first winning transactions, thereby rendering the first group of content slots while the second transaction request is pending; and
loading the second group of content slots of the webpage with one or more second electronic content items corresponding to the one or more second winning transaction after receiving the one or more second winning transactions

9. The system of claim 8, further comprising:
classifying the one or more content slots based on a position of the one or more content slots on the webpage.

10. (canceled)

11. (canceled)

12. The system of claim 8, wherein loading the one or more content slots of the webpage includes loading a first batch of electronic content items prior to loading a second batch of electronic content items.

13. The system of claim 8, wherein classifying the one or more content slots is based on one or more auction controls, the one or more auction controls comprising a bid timeout, a bid start delay, and bidder preference.

14. The system of claim 8, wherein classifying the one or more content slots of the webpage comprises classifying the one or more content slots using a trained machine learning model; and
batching the one or more content slots comprises batching the one or more content slots using the trained machine learning model.

15. A non-transitory machine-readable medium storing instructions that, when executed by a computing system, cause the computing system to perform a method for optimizing webpage loading times, the method including:
receiving, by one or more processors, one or more content slots of a webpage, the one or more content slots including a first group of content slots located above a horizontal threshold of the webpage and a second group of content slots located below the horizontal threshold of the webpage;
classifying, by the one or more processors, the first group of content slots as above-the-fold content slots and the second group of content slots as below-the-fold content slots based on a position of each content slot relative to the horizontal threshold;
batching, by the one or more processors, the first group of content slots based into a first batch and the second group of content slots into a second batch based on the classifying;
customizing, by the one or more processors, a first transaction request corresponding to the first batch with a first parameter timeout value and a second transaction request corresponding to the second batch with a second parameter timeout value, wherein the first parameter timeout value is shorter than the second parameter timeout value;
transmitting, by the one or more processors, the first transaction request to an auction manager prior to transmitting the second transaction request;
receiving, from the auction manager, by the one or more processors, one or more first winning transactions bids for the first transaction request prior to receiving one or more second winning transactions for the second transaction request;
loading, by the one or more processors, the first group of content slots of the webpage with one or more first electronic content items corresponding to the one or more first winning transactions, thereby rendering the first group of content slots while the second transaction request is pending; and
loading, by the one or more processors, the second group of content slots of the webpage with one or more second electronic content items corresponding to the one or more second winning transaction after receiving the one or more second winning transactions.

16. The non-transitory machine-readable medium of claim 15, further comprising:
classifying the one or more content slots based on a position of the one or more content slots on the webpage.

17. (canceled)

18. (canceled)

19. The non-transitory machine-readable medium of claim 15, wherein loading the one or more content slots of the webpage includes loading a first batch of electronic content items prior to loading a second batch of electronic content items.

20. The non-transitory machine-readable medium of claim 15, wherein classifying the one or more content slots of the webpage comprises classifying the one or more content slots using a trained machine learning model; and
batching the one or more content slots comprises batching the one or more content slots using the trained machine learning model.
